(19) United States
(12) Patent Application Publication
(10) Pub. No.: US 2005/0138194 A1
(43) Pub. Date: Jun. 23, 2005

(54) Methods and systems for multi-protocol communication

(75) Inventors: Xiaolin Lu, Plano, TX (US); Manish Goel, Plano, TX (US); Srinath Hosur, Plano, TX (US); Arndt Joseph Mueller, San Diego, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/744,864

(22) Filed: Dec. 23, 2003

(51) Int. Cl. G06F 15/16; G06F 15/173

(52) U.S. Cl. 709/230; 709/223

(57) ABSTRACT

In at least some embodiments, a system may comprise one or more devices configured to communicate according to a first protocol that uses a data frame comprising a header field and a data field and one or more devices configured to communicate according to a second protocol that uses a data frame comprising a header field, a header extension, and a data field. The data frame used by the second protocol may comprise fictitious information for interpretation by the one or more devices configured according to the first protocol. In accordance with some embodiments of the invention, the devices configured according to the first protocol may use the fictitious information to determine a data transmission duration of data packets sent by devices configured according to the second protocol, even though the data packets may be sent according to parameters that are not supported by the first protocol.

### BACKGROUND

Systems are continuously being developed that permit electronic devices to communicate with each other without a wired connection. In order for the devices to communicate, a wireless protocol (i.e., standard) may be used to define hardware and software parameters such that the devices are able to send, receive, and interpret data. For example, the 802.11 standard is provided by the Institute of Electrical and Electronics Engineers (IEEE) and describes medium access control (MAC) and physical layer (PHY) specifications that may be used for wireless local area networks (WLANs). While existing wireless standards allow electronic devices to communicate, it is desirable to increase the data transfer rate between electronic devices to provide improved performance and capabilities to wireless systems. Unfortunately, pre-existing wireless standards may limit the data transfer rate between devices.

### SUMMARY

In at least some embodiments, a system may comprise one or more devices configured to communicate according to a first protocol that uses a data frame having a header field and a data field. The system may further comprise one or more devices configured to communicate according to a second protocol that uses a data frame having a header field, a header extension, and a data field. The data frame used by the second protocol may include fictitious information for interpretation by the one or more devices configured according to the first protocol.

In accordance with some embodiments of the invention, the devices configured according to the first protocol may use the fictitious information to determine a data transmission duration of data packets sent by devices configured according to the second protocol, even though the data packets may be sent according to parameters that are not supported by the first protocol.

### BRIEF DESCRIPTION OF THE DRAWINGS

For a detailed description of various embodiments of the invention, reference will now be made to the accompanying drawings in which:

FIG. 1 illustrates a wireless system in accordance with embodiments of the invention;

FIG. 2 illustrates a data packet used for wireless communication;

FIG. 3 illustrates a data frame in accordance with embodiments of the invention;

FIG. 4 illustrates a method for determining fields of a header and a header extension in accordance with embodiments of the invention; and

FIG. 5 illustrates a data transmission method in accordance with embodiments of the invention.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

Electronic devices that communicate wirelessly may use a variety of techniques to prepare, send, receive, and recover data. For example, data preparation techniques may comprise data scrambling, error correction coding, interleaving, data packet formatting, modulation, and/or other techniques. To send the data, one or more carrier frequencies may be selected and one or more antennas may propagate a wireless signal at the selected carrier frequency(s). To receive the data, one or more antennas may “pick up” the wireless signal, after which the data may be recovered using techniques such as signal amplification, digitization, down-sampling, equalization, demodulation, de-interleaving, de-coding, and/or de-scrambling.

The processes of preparing, sending, receiving, and recovering data as described above may be organized to permit multiple devices to interactively communicate in real-time. During this interaction between multiple devices, there is an ongoing need for efficient data traffic control. For example, if all of the devices of a wireless system send data at the same time, none of the devices may be able to receive data. There are many methods and implementations for providing data traffic control. Some methods of data traffic control may comprise allocating pre-determined time intervals to each device of a wireless system during which each device has an opportunity to send data to another device. Additionally or alternatively, some methods may rely on a contention protocol in which devices attempt to communicate on an as-needed basis. Such methods may provide information (e.g., data transfer rate, amount of data) in each wireless data packet that permits all devices of a wireless system to estimate when a current data transmission will be finished, after which another data transmission may occur.

Another aspect of wireless communication may include providing methods that permit devices which implement different wireless protocols to communicate with each other or at least coexist with each other. As will be described herein, embodiments of the invention may comprise a wireless system, wherein at least one device of the system uses a first protocol and at least one device of the system uses a second protocol. In at least some embodiments, the devices that use the first protocol may communicate with each other using a different (e.g., lower) data transfer rate than the devices that communicate using the second protocol. Additionally, embodiments of the invention may allow devices that use the first protocol to communicate with devices that use the second protocol and vice versa. Additionally, embodiments of the invention may allow devices that use the first and second protocols to efficiently coordinate data traffic control (e.g., clear channel assessment mechanisms).

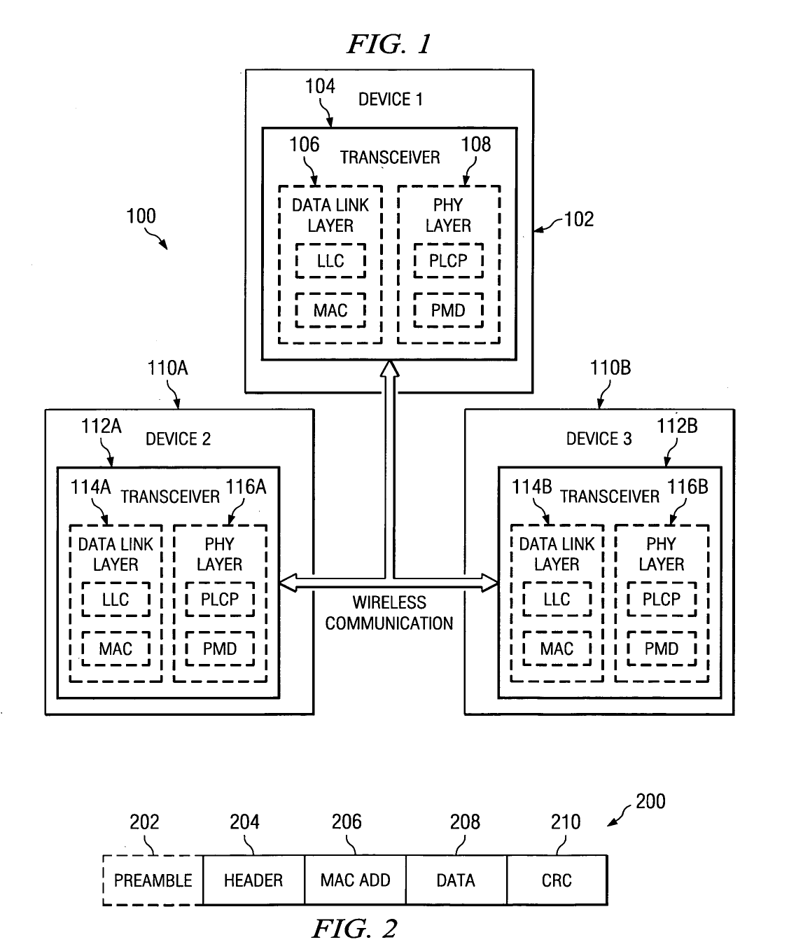

FIG. 1 illustrates a wireless system 100 in accordance with embodiments of the invention. As shown in FIG. 1, the wireless system may comprise the devices 102, 110A, and 110B. The device 102 may comprise a transceiver 104 having a data link layer 106 and a physical (PHY) layer 108. In at least some embodiments, the device 102 may implement a first wireless protocol (e.g., 802.11a, 802.11g). Similarly, each of the devices 110A and 110B also may comprise a transceiver 112A, 112B having a data link layer 114A, 114B and a PHY layer 116A, 116B. In at least some embodiments, the devices 110A and 110B may implement a second wireless protocol (e.g., 802.11n).

ln at least some embodiments, the devices 110A and 110B may communicate with each other using a data transfer rate that is not supported by the first protocol implemented by the device 102. For example, if the first protocol is 802.11a/g, the defined data transfer rates may be described by the Table 1 shown below.

TABLE 1

| Data Rate (Mbps) | Modulation |
|---|---|
| 6 | BPSK |
| 9 | BPSK |
| 12 | QPSK |
| 18 | QPSK |
| 24 | 16-QAM |
| 36 | 16-QAM |
| 48 | 64-QAM |
| 54 | 64-QAM |

As previously described, the first and second protocols may use different data rates to transmit data. Additionally, the second protocol may use different modulations and/or combinations of data rates and modulations than those used by the first protocal. For example, in at least some embodiments, the second protocol may define data rates and associated modulations according to the Table 2 shown below.

TABLE 2

| Data Rate (Mbps) | Modulation |
|---|---|
| 6 | BPSK |
| 9 | BPSK |
| 12 | QPSK |
| 18 | QPSK |
| 24 | 16-QAM |
| 36 | 16-QAM |
| 48 | 16-QAM |
| 72 | 16-QAM |
| 54 | 64-QAM |
| 96 | 64-QAM |
| 108 | 64-QAM |
| 126 | 64-QAM |
| 140 | 64-QAM |

As shown in Table 1 and Table 2, the data rate and modulation definitions used for the first and second protocols may not be compatible. Therefore, embodiments of the invention preferably provide methods and systems that permit the devices 110A, 110B to transmit data to each other according to the second protocol, and permit the devices 110A, 110B to transmit data to the device 102 using the first protocol and vice versa. Additionally, embodiments of the invention may permit the devices 102, 110A, and 110B to estimate/determine the duration of data transfers according to data rates supported by either the first protocol or the second protocol.

In order for the devices 102, 110A, and 110B to communicate wirelessly, the PHY layers 108, 116A, 116B and the data link layers 106, 114A, 114B may perform several functions. For example, the PHY layers 108, 116A, 116B may each implement a physical layer convergence procedure (PLCP) sub-layer and a physical medium dependent (PMD) sub-layer. The PLCP sub-layer may provide an interface whereby carrier sense and clear channel assessment (CCA) signals are provided to the data link layer 106, 114A, 114B indicating whether the PHY layer 108, 116A, 116B is in use. The PMD sub-layer may provide encoding, decoding, modulation, and/or demodulation of data. The PMD sub-layers also may provide analog-to-digital and/or digital-to-analog data conversion.

The data link layer 106, 114A, 114B may implement a logical link control (LLC) and a medium access control (MAC). During transmission of data, the LLC may assemble data into a frame with address and cyclic redundancy check (CRC) fields. During reception of data, the LLC may disassemble a data frame, perform address recognition, and perform CRC validation. The MAC may function, at least in part, to coordinate transmission of data between the electronic devices 102, 110A, and 110B.

FIG. 2 illustrates an exemplary data packet 200 used for wireless data transmission. As shown in FIG. 2, the data packet 200 may comprise a preamble 202, a header field 204, a MAC address field 206, a data field 208, and a CRC field 210. The preamble 202 may be used for synchronization and channel estimation. The header field 204 may provide modulation information, convolution coding rate information, and data length (i.e., number of octets) information. The MAC address field 206 may comprise a hardware address that identifies a node of a network. The data field 208 may comprise a variable amount of scrambled data. The CRC field 210 may comprise information for detecting data transmission errors.

In accordance with at least some embodiments of the invention, one or more fields of a data packet 200 may be added and/or modified in order to permit the devices 110A, 110B to transmit data to each other according to the second protocol, and permit the devices 110A, 110B to transmit data to the device 102 using the first protocol and vice versa as previously described. Additionally, adding and/or modifying fields of a data packet 200 may permit the devices 102, 110A, and 110B to estimate the duration of data transfers (used for CCA) according to data rates supported by either the first protocol or the second protocol.

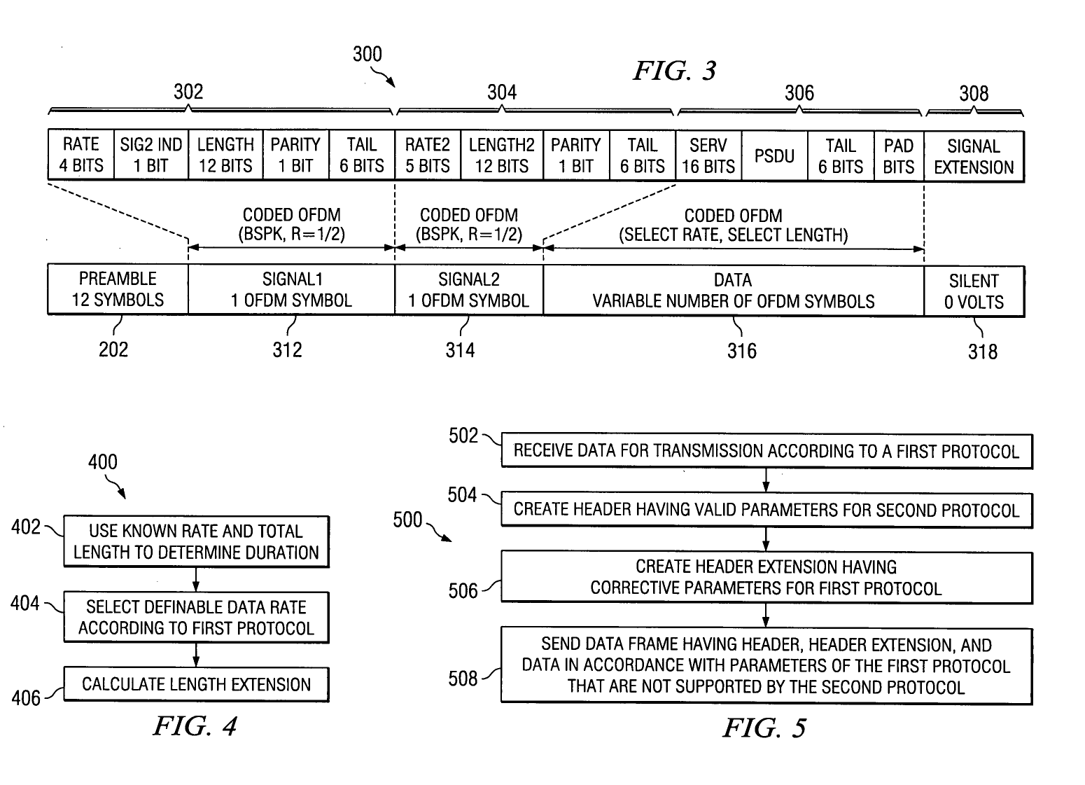

FIG. 3 illustrates a data frame 300 in accordance with embodiments of the invention. In some embodiments, the data frame 300 may comprise a modified PPDU (PLCP Protocol Data Unit) frame. As shown in FIG. 3, the data frame 300 may comprise a header 302 (e.g., a PLCP header), a header extension 304, and data 306 (e.g. PSDU (PLCP Service Data Unit) data). A MAC address frame (not shown) also may be included before or in the data field 306.

The header 302 may comprise a single OFDM (Orthogonal Frequency Division Multiplexing) symbol 312 denoted as “SIGNAL1”. In at least some embodiments, the header 302 may define fictitious information for interpretation by devices that are not compatible with the header extension 304 or other parameters of a protocol. The purpose of the fictitious information will later be described. The SIGNAL1 symbol 312 described above may be transmitted at a rate of 6 Mbps using binary phase shift keying (BPSK) and a coding rate of 1/2. As shown in FIG. 3, the SIGNAL1 symbol 312 may comprise data from a “RATE” field, a “SIG2 IND” field, a “LENGTH” field, a “PARITY” field, and a “TAIL” field. The RATE field may comprise 4 bits of data that identify a data rate having a fixed type of modulation (e.g., BPSK, QPSK, 16-QAM, 64-QAM) and/or a convolutional coding rate (e.g., 1/2, 3/4, 2/3). In at least some embodiments, the RATE field also may contain information that defines a transmission antenna configuration. The SIG2 IND field may comprise 1 bit of data that identifies whether the header extension 304 will be used (i.e., the SIG2 IND field may be used as a flag that indicates when the header extension 304 is used). Alternatively, other methods may be used to determine whether the header extension 304 is used. For example, a “stealth” signal may be transmitted with the header frame 302 using the quadrature component of the signal subcarrier. The stealth signal may be detectable by devices (e.g., devices 110A and 110B) that can interpret the header extension 304 and undetectable to devices (e.g., device 102) that cannot interpret the header extension 304. Alternatively, the stealth signal may be detectable by devices (e.g., device 102) other than those that use the second protocol, in which case the stealth signal, preferably, does not interfere with the normal operation of the non-second protocol device. The LENGTH field may comprise 12 bits of data that identify a number of octets used for the data 306. The PARITY field may comprise 1 bit that identifies a positive parity bit for bits (0-16) of the header 302. The TAIL field may comprise 6 bits used to bring a convolutional encoder to a zero state.

The header extension 304 may be used when the SIG2 IND field bit of the header 302 is asserted (i.e., equal to a logical “1”). As shown, the header extension 304 may comprise a single OFDM symbol 314 denoted as “SIGNAL2”. In at least some embodiments, the header extension 304 may define information regarding parameters used by the second protocol and/or corrective information related to the fictitious information stored in the header 302. The SIGNAL2 symbol 314 described above may be transmitted at a rate of 6 Mbps using BPSK and a coding rate of 1/2. The header extension 304 may comprise a “RATE2” field, a “LENGTH2” field, a “PARITY” field, and a “TAIL” field. The RATE2 field may comprise 5 bits that define a data transfer rate of a second protocol and a corresponding modulation type, coding rate and/or antenna configuration. For example, in some embodiments, the RATE2 field may encode a data transfer rate, a modulation type, a coding rate, and an antenna configuration according to the Table 3 shown below.

TABLE 3

| RATE2 value | | Data Rate | | Antenna |
|---|---|---|---|---|
| (5 bits) | Modulation | (Mpbs) | Coding Rate | Configuration |
| 00000 | BPSK | 6 | ½ | STTD |
| 00000 | BPSK | 9 | ¾ | STTD |
| 00000 | QPSK | 12 | ½ | STTD |
| 00000 | QPSK | 18 | ¾ | STTD |
| 00000 | 16-QAM | 24 | ½ | STTD |
| 00000 | 16-QAM | 36 | ¾ | STTD |
| 10001 | 16-QAM | 64 | ⅔ | VLST |
| 10000 | 16-QAM | 72 | ¾ | VLST |
| 00001 | 64-QAM | 48 | ⅔ | STTD |
| 00000 | 64-QAM | 54 | ¾ | STTD |
| 10001 | 64-QAM | 96 | ⅔ | VLST |
| 10000 | 64-QAM | 108 | ¾ | VLST |
| 10010 | 64-QAM | 126 | ⅞ | VLST |
| 10110 | 64-QAM | 140 | ⅞ | VLST |

In at least some embodiments, the encoding for the RATE2 field bits (B4-B0) may be defined as described below. When the RATE2 field is “00000” the actual rate can be completely inferred from the RATE field in the header 302. In at least some embodiments, the bit “B4” may be a MIMO (Multiple Input Multiple Output) indication bit, wherein a “0” value indicates STTD (Space-Time Transmit Diversity) and a “1” value indicates VLST (Vertical Layered Space Time) diversity. The bit “B3” may be defined as a channel bonding indicator bit, wherein a “1” value indicates that a channel bonding mechanism is used. For example, one such channel bonding mechanism may simultaneously transmit data frames over two adjacent channels as if it were a single channel with twice the bandwidth. The bit “B2” may be defined as a shortened guard interval indicator bit, wherein a “1” value indicates a shortened guard interval has been used (e.g., the interval guard may be shortened from 800 ns to 400 ns when a data rate of 140 Mbps is used). The bits “B1” and “B0” may be used to indicate a coding rate. For example, a “00” value may indicate the coding rate for RATE2 is same as the coding rate defined in the RATE field, a “01” value may indicate a 2/3 coding rate, a “10” value may indicate a 7/8 coding rate.

As shown in the Table 3, the RATE2 value (encoding) may be the same for multiple data rates. For example, the data rates 96 Mbps and 64 Mbps both share the RATE2 value “10001.” This RATE2 value indicates to devices configured according to the second protocol that VLST as well as a 2/3 coding rate are being used to transmit data. In some embodiments, the devices configured according to the second protocol may use the RATE field in SIGNAL1 312 to distinguish between when the data rate is 96 Mbps or 64 Mbps. For example, if the RATE field encodes a certain data rate value (e.g., 48 Mbps), then the RATE2 may be assumed to be 96 Mbps. Therefore, information included in the RATE field and the RATE2 field of a data frame 300 may be used by devices configured according to the second protocol to encode and interpret data transfer parameters. Accordingly, in at least some embodiments, the RATE2 field may use 4-bits rather than 5-bits to define a data transfer rate, a modulation type, a coding rate and/or an antenna configuration. In such embodiments, the extra bit (i.e., the previously explained 5^{th} bit) may be reserved for future use.

The LENGTH2 field may comprise 12 bits. In some embodiments, the LENGTH2 field may be used when the total size of the data 306 exceeds 4095 octets (i.e., the maximum number of octets that may be described by the LENGTH field of the header 302). The PARITY field may comprise 1 bit that identifies a positive parity bit for bits (0-16) of the header extension 304. The TAIL field may comprise 6 bits (e.g. all “0s”) used to bring a convolutional encoder to a zero state. In accordance with at least some embodiments, one or more header extensions 304 may be added to a data frame 300 to define different modulations, coding rates, antenna configurations, and/or data rate mappings.

The data 306 may comprise a “SERV” field, a “PSDU” field, a “TAIL” field, and a “PAD BITS” field. The SERV (i.e., service) field may comprise 16 bits used to synchronize a descrambler in a receiver (e.g., transceiver 104A, 104B). The PSDU field may comprise a variable amount of data. The TAIL field may comprise 6 bits used to bring a convolutional encoder to a zero state. The PAD BITS field may comprise a one or more bits (e.g., all “0s”) that extend the length of the PSDU data 306 to be a multiple of the number of data bits per OFDM symbol (N_{DBPS}). In at least some embodiments, the N_{DBPS} may be calculated as:
N_{DBPS}=(Data Transfer Rate)*(3.2+T_{GI}) (1)

In equation (1), the Data Transfer Rate may comprise a data rate defined by the RATE field or the RATE2 field, and the T_{GI} value may comprise a time allocated for a guard interval (i.e., a time interval between symbols for reducing inter-symbol interference).

As shown in FIG. 3, the data frame 300 may also comprise a preamble 202 and a signal extension 308, 318. The preamble 202 may comprise a number of symbols (e.g., 12 symbols) that are used for synchronization and channel estimation. The signal extension 308, 310 may comprise a time period of silence (i.e., no data is transmitted) that provides a receiving system with additional time to decode the data 306 before receiving another data frame 300. For example, the signal extension time period may comprise approximately 4 μs.

Using the data frame 300 described above with suitable data link layers (e.g., data link layers 106, 114A, 114B) and/or PHY layers (e.g., PHY layers 108, 116A, 116B) allows devices (e.g., 102, 110A, 110B) of a wireless system (e.g., system 100) to calculate the duration of data transfers in accordance with a first protocol or a second protocol.

In at least some embodiments, the devices 110A and 110B may create and interpret a data frame 300 as part of the second protocol. Additionally, the second protocol may permit the devices 110A and 110B to interpret data frames that do not include the header extension 304 (e.g., data frames sent from the device 102). The device 102 may create and interpret data frames that do not include the header extension 304 in accordance with a first protocol. In at least some embodiments, the device 102 is unaware of header extensions 304 and may interpret a header extension 304 as the first OFDM symbol in the data field 208. Therefore, when a first protocol device (e.g., device 102) receives a second protocol data packet (e.g., data frame 300), the first protocol device may interpret the data packet up to and including the first header (which enables the first protocol device to determine the duration of the packet) and will attempt, but fail, to decode the remainder of the data packet. A number of examples using the wireless system 100 shown in FIG. 1 illustrate how embodiments of the invention may function.

In a first example, the device 102 may transmit a wireless signal. The devices 110A and 110B may both receive the wireless signal and examine information provided with a data frame of the wireless signal. As previously described, the device 102 may transmit data packets 200 that include a header (e.g., header 204) and data (e.g., data 208), but do not include a header extension 304. If the wireless signal is intended for the device 110A, then the device 110A may recognize the recipient address and recover the data using data recovery techniques such as those described previously. Meanwhile, the device 110B may not recognize the recipient address, but may still use information provided with a header 204 of the data packet 200 (e.g., data rate, data length) to calculate the duration of the data transmission. For example, the duration of the data transmission may be calculated (in number of OFDM symbols) by the device 110B as:
Duration=ceil ((16+LENGTH*8+6)/N_{DBPS}) (2)

In equation (2), the ceil (A) function rounds the value of A to the nearest integer greater than or equal to A. The NDBPS value may be calculated using a data transfer rate (RATE) used by the device 102. More specifically, the N_{DBPS} value is defined in equation (1). The LENGTH value may equal the number of octets in the data field in accordance with the first protocol implemented by the device 102.

Returning to the example, if the devices 110A and/or 110B detect that the SIG2 IND field is set to zero (or alternatively, if the devices 110A or 110B do not detect the “stealth” signal), then the devices 110A and/or 110B may function according to the first protocol Oust as the device 102).

In a second example, the device 110A may transmit a wireless signal. The devices 102 and 110B may both receive the wireless signal and examine information provided with a data frame of the wireless signal. As previously described, the device 110A may transmit a data frame 300 having a header 302 and a header extension 304. Alternatively, if the wireless signal is intended for the device 102, then the data frame may not include the header extension 304. If the device 110A does transmit a header extension 304, the device 110B may interpret (e.g., by means of the SIG2 IND bit in the header 302) that a header extension 304 follows. In contrast, the device 102 may ignore or throw out the header extension 304 and subsequent data frame fields as erroneous data. Accordingly, in some embodiments, the device 110B may use the information in both the header 302 and the header extension 304 to calculate the duration of the data transmission. For example, the device 110B may calculate the duration of the data transmission (in number of OFDM symbols) as:
Duration=ceil((16+(LENGTH+LENGTH2)*8+6)/N_{DBPS(2nd protocol)}) (3)

In equation (3), the ceil (A) function rounds the value of A to the nearest integer greater than or equal to A. The LENGTH value may comprise a value defined in the LENGTH field of header 302. The LENGTH2 value may comprise a value defined in the LENGTH2 field of the header extension 304. The N_{DBPS2} value may be defined by equation (1), wherein the Data Transfer Rate (RATE2) used for equation (1) is the actual data rate set by the device 110A to transmit the data frame 300. As previously explained, the RATE2 field value may be selected according to the modulation scheme, antenna configurations and/or coding rate parameters defined in Table 3.

In a third example, the device 110A may transmit a wireless signal. The devices 102 and 110B may both receive the wireless signal and examine information provided in a data frame (e.g., data frame 300) of the wireless signal. As previously described, the device 110A may transmit a data frame 300 (including a header extension 304) or a data packet 200 (without a header extension 304). If a header extension 304 is included, the device 102 may not interpret the header extension 304 and/or subsequent data frame fields, but may still use information provided with the header 302 of the data frame 300 to calculate the duration of the data transmission. For example, the duration of the data transmission may be calculated by the device 102 using the equation (2) described above.

In order for all the devices of the wireless system 100 to correctly calculate the duration of a data transmission, the devices 110A and 110B may provide field values in the header 302 that allow an accurate estimation of the actual data transmit duration. In some embodiments, the RATE2 value in the header extension 304 is the actual data transmission rate used to transmit the payload of the data frame 300. Additionally, the value of LENGTH+LENGTH2 may be the actual number of octets of the data frame 300 (not including the header 302 and header extension 302). The selection of the RATE, LENGTH and LENGTH2 fields may be determined according to the following equation:
ceil ((16+LENGTH*8+6)/N_{DBPS(1st protcol)})=
ceil((16+(LENGTH+LENGTH2)*8+6)/N_{DBPS(2nd protocol)}); (4)

In equation (4), the duration of transmission (i.e., the number of symbols) calculated using the length (LENGTH field value) and data rate (RATE field value) information in the header 302 (i.e., equation 2) is made equal to the duration of transmission calculated using the length (LENGTH field value) from the header 302, the length (LENGTH2 field value) from the header extension 304, and the data rate (RATE2 field value) from the header extension.

In some embodiments, the LENGTH2 value may be a corrective value that is added to the LENGTH value (e.g., as shown for equation 4). Alternatively, the LENGTH2 value may represent that actual (true) length of a data frame transmitted according to a second protocol.

FIG. 4 illustrates a method for providing data rate (RATE) and data length (LENGTH and LENGTH2) values for a header (e.g., header 302) and a header extension (e.g., header extension 304) in accordance with embodiments of the invention. As shown in FIG. 4, the method 400 may comprise using a known data rate (RATE2) and a total data length (LENGTH+LENGTH2) to determine a duration of data transmission (block 402). For example, equation (3) may be used with these values to determine a transmission duration. At block 404, a data rate (RATE) definable according to a first protocol may be selected. For example, when the actual data transmit rate (RATE2) is defined according to the first protocol (e.g., the data rate is defined in Table 1), both the RATE and RATE2 values may be set to this same data transmit rate. Alternatively, if the actual data transmit rate (RATE2) is not defined according to the first protocol (e.g., the data rate is not defined in Table 1), the RATE value may be assigned a value defined according to the first protocol, while the RATE2 value may be assigned a different value. For example, the Table 4 shown below illustrates a number of combinations of RATE values and RATE2 values that may be used in some embodiments.

TABLE 4

| | | | |
|---|---|---|---|
| RATE2 (Actual | RATE (Used for | | |
| Data Rate in | duration calculation | | Antenna |
| Mbps) | in Mpbs) | Coding Rate | Configuration |

| | | | |
|---|---|---|---|
| 6 | 6 | ½ | STTD |
| 9 | 9 | ¾ | STTD |
| 12 | 6 | ½ | STTD |
| 18 | 9 | ¾ | STTD |
| 24 | 12 | ½ | STTD |
| 36 | 18 | ¾ | STTD |
| 48 | 24 | ⅔ | VLST |
| 54 | 24 | ¾ | VLST |
| 64 | 36 | ⅔ | VLST |
| 72 | 36 | ⅔ | STTD |
| 96 | 48 | ¾ | STTD |
| 108 | 54 | ⅔ | VLST |
| 126 | 54 | ¾ | VLST |
| 140 | 54 | ⅞ | VLST |

In at least some embodiments, the RATE2 values shown in the Table 4 may be the actual data transfer rate according to a second protocol, while the RATE values are data transfer rates that are definable according to a first protocol (e.g., Table 1 illustrates data transfer rate values according to an exemplary first protocol).

At block 406, a length extension (LENGTH2) value may be calculated using the duration calculation of block 402 and the RATE selection of block 404. More specifically, a length (LENGTH) value may be discovered by using equation (1), wherein the duration value calculated at block 402 and the RATE value selected at block 404 are used to calculate the length (LENGTH) value. The length extension (LENGTH2) may then be calculated by subtracting the LENGTH value from the total LENGTH+LENGTH2 value previously described.

As an example, consider a device configured according to a second protocol that may transmit a total data length (LENGTH+LENGTH2) of 8190 bytes using an actual data rate (RATE2) of 108 Mbps and a guard interval (T_{GI}) equal to 0.8 μs. According to equation (1), N_{DBPS(2nd protocol)}=432. By using LENGTH+LENGTH2=8190 and N_{DBPS(2nd protocol)}=432 in equation (4), the duration calculation (at block 402) equals 153. This 153 value is an approximation of the actual duration of transmission (i.e., the number of symbols for the transmission) according to the second protocol.

At block 404, a fictitious RATE value of 54 Mbps which corresponds to the actual 108 Mbps data rate (RATE2) (shown in Table 4) may be selected. At block 406, the RATE value and the predicted duration of 153 (shown above) may be used with equations (1) and (2) to determine a LENGTH value as previously explained. In this example, the LENGTH value is equal 4095. At block 406, the LENGTH2 value (the length extension) may be calculated by subtracting the LENGTH value from the total LENGTH (LENGTH+LENGTH2) described above. In the present example, the length extension (LENGTH2) may equal 8190−4095=4095.

Therefore, in some embodiments, a second protocol device (e.g., the devices 110A and 110B) may store the fictitious LENGTH field value (4095) and the fictitious RATE field value (54 Mbps) if a header 302 for use by a first protocol device (e.g., the device 102). Additionally, a second protocol device may store the actual data rate in the RATE2 field and a corrective length extension in the LENGTH2 field of header extension 304 for use by other second protocol devices. Therefore, all first protocol and second protocol devices may accurately determine the transmission duration of a data frame 300. This is true, even though the data transfer rate and/or other transmission parameters of the data frame 300 are not defined for the first protocol device.

FIG. 5 illustrates a method 500 in accordance with embodiments of the present invention. For example, the method 500 may be performed by devices (e.g., devices 110A, 110B) that implement a second protocol that, at least in part, is not supported by other devices (e.g., device 102) of a communication system (e.g., system 100).

As shown in FIG. 5, the method 500 may comprise receiving data for transmission (block 502). At block 504, a header (e.g., header 302) having valid parameters for a first protocol may be created. For example, the PHY layers 116A, 116B of the devices 110A, 110B may create a header 302 having fictitious data rate parameters and/or data length parameters as previously described. At block 506, a header extension (e.g., header extension 304) having corrective parameters for the second protocol may be created. As previously described, the header extension 304 may comprise data rate parameters and/or data length parameters interpretable by the devices (e.g., 110A, 110B) that implement the second protocol but not by devices (e.g., device 102) that implement a first protocol. At block 508, a data frame having the header (created at block 504), the header extension (created at block 506), and data may be transmitted (i.e., sent) in accordance with parameters of the second protocol that are not supported by the first protocol (e.g., the data may be sent at a data rate that is not supported by the first protocol).

The above discussion is meant to be illustrative of the principles and various embodiments of the present invention. Numerous other variations and modifications will become apparent to those skilled in the art once the above disclosure is fully appreciated. For example, other embodiments may use wireless devices that implement more than two protocols. In such embodiments, additional header extensions may be used to provide compatibility between the devices as described above. Additionally, the header extension may be implemented using a variety of encoding schemes and/or modulation schemes. For example, in some embodiments a header extension may include additional or fewer bits. More specifically, quadrature phase shift keying (QPSK) may be used to transmit the header extension, wherein 48-bits may be used to encode a variety of information. The information in the header extension may be used for a variety of purposes such as those illustrated above. It is intended that the following claims be interpreted to embrace all such variations and modifications.

1. A system, comprising:
one or more devices configured to communicate according to a first protocol that uses a data frame comprising a header field and a data field; and
one or more devices configured to communicate according to a second protocol that uses a data frame comprising a header field, a header extension, and a data field,
wherein the data frame used by the second protocol comprises fictitious information for interpretation by the one or more devices configured according to the first protocol.

2. The system of claim 1 wherein the data frame used by the second protocol further comprises corrective information for interpretation by the one or more devices configured according to the second protocol.

3. The system of claim 1 wherein the data frame used by- the second protocol further comprises a flag signal that indicates existence of the header extension.

4. The system of claim 1 wherein the fictitious information comprises data rate information.

5. The system of claim 1 wherein the fictitious information comprises data length information.

6. The system of claim 1 wherein the fictitious information is contained in the header field of the data frame used by the second protocol.

7. The system of claim 2 wherein the corrective information comprises at least one type of information selected from the group consisting of data rate information and data length information.

8. The system of claim 1 wherein the fictitious information is used by the one or more devices configured according to the first protocol to calculate a data transmission duration between devices configured according to the second protocol.

9. The system of claim 1 wherein the one or more devices configured according to the second protocol transmit data using one or more parameters that are not defined for the first protocol.

10. The system of claim 1 wherein the header extension encodes an antenna configuration.

11. The system of claim 1 wherein the header extension encodes a shortened guard interval.

12. The system of claim 1 wherein the header extension encodes a channel bonding mechanism.

13. The system of claim 1 wherein the first protocol is an 802.11 protocol.

14. A method, comprising:
receiving data for transmission;
creating a header having valid parameters for a first protocol;
creating a header extension having corrective parameters for use by a second protocol; and
sending a data frame having the header, the header extension, and data, wherein the data is sent in accordance with one or more parameters of the second protocol that are not supported by the first protocol.

15. The method of claim 14 wherein the header further comprises a signal that indicates existence of the header extension.

16. The method of claim 14 wherein creating a header having valid parameters for a first protocol comprises calculating a transmission duration using at least one of the one or more parameters of the second protocol that are not supported by the first protocol.

17. The method of claim 16 wherein creating a header having valid parameters for a first protocol further comprises using the calculated transmission duration to determine the valid parameters.

18. The method of claim 17 wherein the valid parameters comprise data rate information definable according to the first protocol.

19. The method of claim 17 wherein the valid parameters comprise data length information definable according to the first protocol.

20. The method of claim 14 wherein creating a header extension having corrective parameters for use by the second protocol comprises determining a corrective data length.

21. The method of claim 14 wherein creating a header extension having corrective parameters for use by the second protocol comprises determining a corrective data rate.

22. The method of claim 14 further comprising encoding the header extension with at least one item selected from the group consisting of antenna configuration information, channel bonding information, and shortened guard interval information.

23. A system, comprising:
means for creating a header having fictitious values in accordance with a first protocol;
means for creating a header extension having corrective values for use by a second protocol; and
means for sending a data frame having the header, the header extension, and data, wherein the data is sent in accordance with one or more parameters of the second protocol that are not supported by the first protocol.

24. The system of claim 23 further comprising means for determining the fictitious values that permit one or more devices that communicate according to the first protocol to estimate a transmission duration of the data frame sent in accordance with one or more parameters of the second protocol that are not supported by the first protocol.

25. The system of claim 23 further comprising means for signaling the existence of the header extension in the header.

26. The system of claim 23 further comprising means for interpreting the corrective values included in the header extension.

27. The system of claim 23 further comprising means for combining and interpreting one or more of the fictitious values and one or more of the corrective values to determine a transmission duration of the data frame.

28. The system of claim 23 further comprising means for encoding the header extension with one or more items selected from the group consisting of antenna configuration information, channel bonding information, and shortened guard interval information.

29. A modulated electromagnetic signal that includes a data frame, wherein the data frame comprises:
a header that provides a misrepresentation of parameter values for use by one or more devices that implement a first protocol;
a header extension that provides corrective parameter values for use by one or more devices that implement a second protocol; and
data, wherein the data is transmitted in accordance with one or more parameters of the second protocol that are not supported by the first protocol.

30. The electromagnetic signal of claim 29 wherein the misrepresentation of parameter values may comprise at least one type of information selected from the group consisting of data transfer rate and data length.

31. The electromagnetic signal of claim 29 wherein the corrective parameter values may comprise at least one type of information selected from the group consisting of data transfer rate and data length.
